(19) United States
(12) Patent Application Publication
(10) Pub. No.: US 2015/0221006 A1
(43) Pub. Date: Aug. 6, 2015

(54) SYSTEM, METHOD AND COMPUTER READABLE MEDIUM FOR TRADING

(71) Applicants: Narayan Sainaney, Vancouver (CA); Justin Patrick Devlin, Burnaby (CA); Matthew Brook Wilson Schmidt, Vancouver (CA)

(72) Inventors: Narayan Sainaney, Vancouver (CA); Justin Patrick Devlin, Burnaby (CA); Matthew Brook Wilson Schmidt, Vancouver (CA)

(21) Appl. No.: 14/170,011

(22) Filed: Jan. 31, 2014

(51) Int. Cl. G06Q 30/06; G06Q 30/02

(52) U.S. Cl. CPC G06Q 30/0613; G06Q 30/0282

(57) ABSTRACT

Localized trades for goods and services are posted online in return for other goods and services. Users of the system closing deals and executing trades provide feedback to each other and the system calculates a ranking for each user. A deal may be closed with an IOU, which the system keeps track of until it has been honoured. Trades involving more than two people can be concluded.

### FIELD OF THE INVENTION

The present invention pertains to the field of trading, and more specifically to a system, method and computer readable medium for peer-to-peer social trading assisted by traders' electronic devices connected via a network to the system.

### BACKGROUND

Consumers today have a choice between various different online platforms that can be used for buying, selling or trading goods and services. There are different levels of tangible outcome and social interaction associated with each.

For example, Craigslist™ has a very large scope, with a high degree of tangible outcomes, but has a low level of social interaction and can be prone to scam artists. Ebay™ also has a high level of tangible outcomes, with a large array of products available internationally, but has minimal social interaction. Etsy™ is a niche site predominantly for crafters to sell hand-made items. It has a high level of tangible outcome and a low level of social interaction. Yerdle™ is a platform that allows things to be traded in connection with existing social networks. TaskRabbit™ is a platform for auctioning basic services and tasks. Streetbank™ is a site that allows users to trade and to borrow basic tools in one's neighborhood. Google Mine™ is a trading platform for Google™ users. Facebook™′ Instagram™ and Twitter™ are all well-known social network sites with a high level of social interaction and a low level of tangible trading outcomes.

In times of recession, unemployment or under-employment, people tend to collectively use what they have, and to share what they have. There is also a growing awareness of responsible consumption, and an ongoing desire for people to be thought well of in their social circles.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

The subject matter disclosed is a discovery platform for new and responsible exchanges, which grows with every exchange. Users make available the things that they have to exchange, such as time, skills and products. It is also a community development platform that facilitates offline relationships, experiences and peer-to-peer social collaborative commerce.

Disclosed herein is a computer implemented method for trading, the method comprising: receiving, by a processor, from a first user device, an input describing a trade; adding, by the processor, the trade to a database; transmitting, by the processor, the trade to a second user device; receiving, by the processor, from one or both of the first and second user devices, an input indicating that the trade has been closed; receiving, by the processor, from one or both of the first and second user devices, an input indicating that the trade has been executed; sending, by the processor, a prompt to the first and second user devices requesting feedback relating to the trade; receiving, by the processor, feedback relating to the trade from one or both of the first and second user devices; and updating, by the processor, a rank of one or both of a first user using the first user device and a second user using the second user device based on the received feedback.

Also disclosed herein is a computer readable medium for trading, the medium comprising computer readable instructions, which, when executed by one or more processors cause the one or more processors to: receive, from a first user device, an input describing a trade; add the trade to a database; transmit the trade to a second user device; receive, from one or both of the first and second user devices, an input indicating that the trade has been closed; receive, from one or both of the first and second user devices, an input indicating that the trade has been executed; send a prompt to the first and second user devices requesting feedback relating to the trade; receive feedback relating to the trade from one or both of the first and second user devices; and update a rank, of one or both of a first user using the first user device and a second user using the second user device, based on the received feedback.

Still further disclosed herein is a system for trading, comprising: one or more computer readable media comprising a database and computer readable instructions; and a processor that executes said computer readable instructions, which cause the processor to: receive, from a first user device, a first input describing a first trade; receive, from a second user device, a second input describing a second trade; receive, from a third user device, a third input describing a third trade; add the first, second and third trades to a database; receive, from the first user device, an input indicating that the first trade has been closed with a user of the second device; receive, from the second user device, an input indicating that the second trade has been closed with a user of the third device; receive, from the third user device, an input indicating that the third trade has been closed with a user of the first device; receive, from the first, second and third user devices, inputs indicating that the respective trades have been executed; receive, from the first, second and third user devices, feedback relating to the respective trades; and update a rank of a first user using the first user device, a rank of a second user using the second user, and a rank of a third user using the third user device based on the respective received feedback.

### BRIEF DESCRIPTION OF THE DRAWINGS

The drawings illustrate aspects of the invention, and should not be construed as restricting the scope of the invention in any way. Drawings are not to scale.

FIG. 1 is a schematic diagram of an exemplary system connected to users' personal electronic devices via a network.

FIG. 2 shows a flow diagram of an exemplary method performed by the system.

FIG. 3 is a screen map produced by an exemplary embodiment of the invention.

FIG. 4 is a flow diagram illustrating an exemplary method performed by the system.

### DETAILED DESCRIPTION OF THE INVENTION

### Definitions

The term “user” is used to describe an individual who interacts with the system, and can be someone who offers something to trade, requests something to trade or simply browses the trades and activities of other users. A user may be referred to as a peer.

The term “user device” refers to a user's personal electronic device, or a device that a user is personally using. A user device may be owned by the user who is using it, or it may be borrowed from someone else. The user device may, for example, be a mobile device, such as a smart phone, tablet, media player, laptop computer or it may be a static device, such as a desktop computer.

The term “network” can include one or more of the internet, an Ethernet, a mobile network and a data network without limiting the term's meaning, and includes the use of wireless (2G, 3G, 4G, WiFi, WiMAX, Wireless USB, Zigbee, Bluetooth and satellite, etc.) and/or hard wired connections such as internet, ADSL, DSL, cable modem, T1, T3, fibre, dial-up modem. A network may include connections to interfaces, electronic devices, flash memory data cards and/or USB memory sticks where appropriate. A network could also mean dedicated connections between computing devices and electronic components, such as buses for intra-chip communications.

The term “server” is used to refer to any computing device, or group of devices, that provide the functions described herein as being provided by one or more servers.

The term “processor” is used to refer to any electronic circuit or group of circuits that perform calculations, and may include, for example, single or multiple processors, single or multicore processors, ASICs and dedicated circuits implemented, for example, on a reconfigurable device such as an FPGA. If a processor has multiple constituent processors, some or all may be co-located or geographically distributed.

The term “database” refers to both persistent and volatile means of storing information suitable for performing computing functions such as searching, inserting, retrieving and updating. Typically, these are relational databases such as in MySQL. It is also possible to use no-SQL databases, in-memory data structures, plain computer files or any other means of storing data. A database may be a parallel system database in which the processors are tightly coupled and constitute a single database system, or it may be a distributed database in which storage devices are not all attached to a common processing unit such as a CPU, and is controlled by a distributed database management system. A distributed database system may be stored in multiple computers, located in the same physical location; or may be dispersed geographically over a network of interconnected computers.

The term “hardware” includes, but is not limited to, the physical housing for a computer as well as the display screen, connectors, wiring, circuit boards having processor and memory units, power supply, and other electrical components. It could also be a system on chip, or system on package.

The term “software” includes, but is not limited to, program code that performs the computations necessary for performing the functions of the system.

The term “firmware” includes, but is not limited to, persistently-stored program code and data used to control and manage the interactions between the various modules of the system.

System

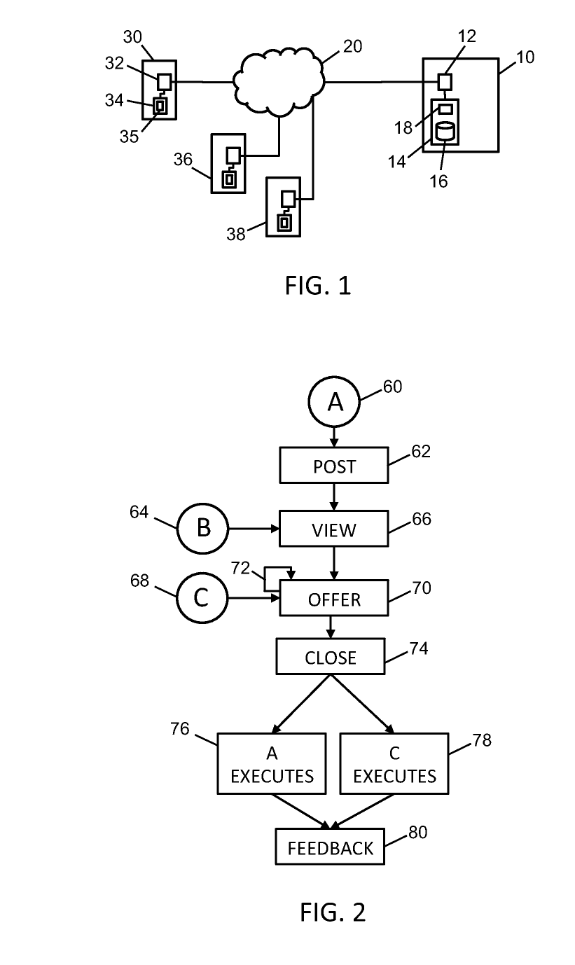

A schematic diagram of an exemplary embodiment of the system is shown in FIG. 1. The main part of the system is embodied on a server 10, the minimum components of the system being a processor 12 connected to a memory 14, in which there is stored a database 16 and computer readable instructions 18. The computer readable instructions 18, in conjunction with the data stored in the database 16, provide the functionality of the system as a result of processing by the processor 12.

The server 10 is connected via network 20 to a user device 30, which typically includes a processor 32 connected to a memory 34 that stores computer readable instructions 35. The processor 32 executes the computer readable instructions 35 and works in conjunction with the processor 12 in the server 10 to assist the user device interact with the system. Other similar user devices 36, 38 are connected to the network 20 and interact with the server 10. The network may be the internet, a telecommunications network or a combination of both. It may also be an Ethernet. The system may optionally be considered to include the computer readable instructions 35 in each device 30, 36, 38 and the memory 34 that carries them. The system may further optionally be considered to include the personal user devices 30, 36, 38.

The user device 30 may be a mobile device, such as a smart phone, tablet, media player, laptop computer or it may be a static device, such as a desktop computer. The user device 30 may be owned by the user who is using it, or it may be borrowed by the user from someone else. Alternately, a business-owned device, charity-owned device or other non-personally owned device may be used.

The system provides a website, for example, which users may browse using user devices 30, 36, 38. Users may post trades to the website, offer exchanges for trades that are posted, and close deals between each other. The website keeps track of each user's reputation, which assists other users in deciding whether to trade with a particular user.

Referring to FIG. 2, a flowchart of an exemplary method that the system fulfils is shown. User A 60 starts the method by posting a trade to the system in step 62. User A may be offering something such as a service or a product, and posts it by uploading details of it to the website provided by the system. The details may include a description and optionally one or more photos. Category tags may also be used to describe the post. Alternately, the post may be for something that User A wants, i.e. the post could be an ask. The post may be made accessible in a pre-configured locality in which the user lives, or the user may choose from various options where the post should appear. The locality may be selected automatically by the system, and the size of the locality may be made dependent on the detail of the posted trade and/or the potential number of viewers of the trade. Other criteria for defining the locality are possible.

User B 64 then views the posted trade in step 66. User B may have entered one or more search terms in order to be presented with the posted trade, or the system may present the trade to User B in a default or home screen that shows the latest posted trades in User B's locality. In other cases, User B may have requested automatic notifications of newly posted trades meeting certain criteria, which are provided by push technology. User B may view the post at different levels of detail, such as title only, title with thumbnail image, or full image with complete detail, and may scroll through multiple images.

Likewise, User C 68 may view the posting, and in this case makes an offer in step 70. The offer may be for something that User A is asking for, or it may be anything else, for example in cases where User A offers something without posting what he wants in return. In response to the system receiving the offer, it is forwarded on to User A, and optionally displayed on the website. As a result of receiving the offer, User A may accept it as is, or propose a counter offer. The cycle 72 of offer and counter offer continues until both User A and User C reach agreement. At this point, the deal is closed in step 74. Details of the concluded trade, either in full or in part, may be optionally posted on the website for User B and other users to see. Following closure of the deal, User A executes his obligation in step 76 and User C executes his obligation in step 78. Execution may simply be, for example, the delivery or giving of a product to the other user. These latter two steps may be executed simultaneously, in tandem or at different times, after which one or more parties to the deal inform the system via the website that the deal has been executed. The system then in step 80 requests and receives feedback from each of User A and User C. The feedback is then added to the respective user's profile for other users of the system to see. Feedback may include one or more rankings relating to different aspects of the exchange, and comments. Feedback may be made anonymous or it may be attributed to the user giving the feedback.

The feedback system allows users, who are otherwise strangers to each other, to connect with confidence with each other in order to trade goods and services, since it is a representation of each user's reputation and trustworthiness. A user's ranking may also be influenced by the frequency at which he trades. A user's ranking may be influenced by the number of offers the user makes in relation to the number of deals closed. For example, someone who makes too many offers without closing a deal can earn a poor reputation, as can a person who posts a profile photo that is not genuine.

In some cases an IOU may be used to close a deal, particularly when one party to the deal delivers immediately but the other party delivers the reciprocal part of the deal at a future date. The system manages such IOU's and any outstanding receivable trades. IOU's may be traded and the system maintains a ledger of who owns the IOU's.

An example of a trade is the exchange of a haircut for a used-once pair of shoes. Another example of a trade may be the offer to provide a haircut in exchange for a particular item and $20.

In some cases the posted trade may not receive any offer, as in step 70, or may receive inadequate offers and/or counter offers. In these cases, the method may end with no agreement being reached, and no closure of a deal as in step 74. The posted trade may then be deleted from the website and/or archived after a certain period of time.

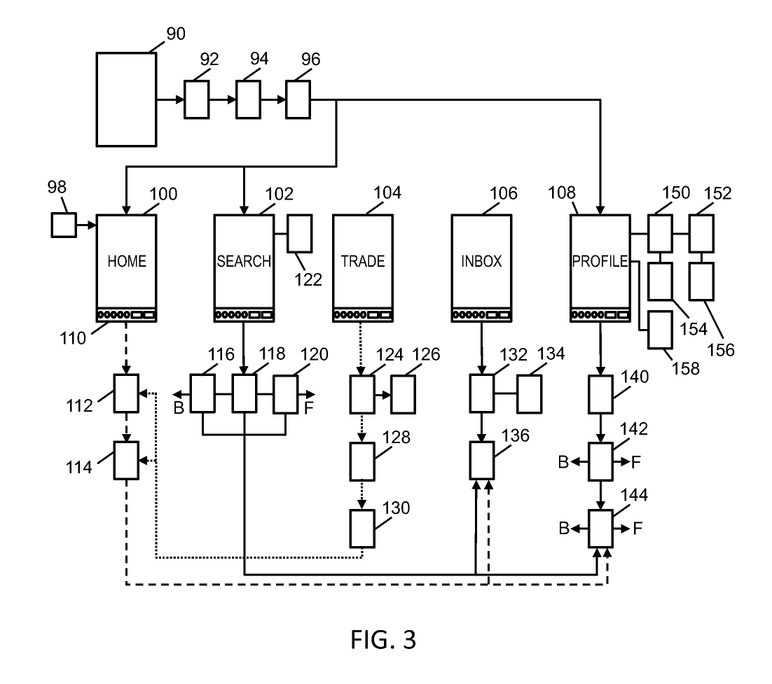

Referring to FIG. 3, a screen map, displayed on user devices 30, 36, 38 to users of an exemplary embodiment of the system, is shown. The larger blocks show the main pages of each section of the application, and the smaller blocks show pages that may be navigated to from the main pages, or they may represent functions provided when on a main page. While some arrows are shown, they do not necessarily imply a one-way navigation through the screen map. Furthermore, the various screens may be linked directly to each other without necessarily being shown to do so on the map by solid, dashed or dotted lines.

Screen 90 is a landing page, such as the home page of the website provided by the system. Screens 92, 94 are introductory and/or login pages, and screen 96 is an exploration page. From the exploration page 96, the user may navigate to the home page 100. An alternate way of navigating to the home page 100 may be by the user clicking on an icon 98 that is linked to the URL of the home page. The home page 100 is one of five main screens of the system, the other screens being the search screen 102, the trade screen 104, the inbox screen 106 and the user profile screen 108. At the bottom of the main screens there is a navigation button bar 110, which, for example, includes one button for navigating to each of the main screens and two addition toggles or buttons.

The home page 100 displays information such as a summary status, last activity, notifications of messages, new postings, etc. A user may browse the home screen like a magazine, for example. From home screen 100, the user can navigate to screen 112 showing a list view of trades and activity posted. From the list view in screen 112, the user can navigate to a detailed page 114 of each trade or each activity of the user.

The main search page 102 may be used for searching for a trade, e.g. searching for shoes or for movers. The search page 102 be toggled to a detailed view of a trade or a person in screen 116, a detailed view of an ask or an offer in screen 118, and a view of a location specific map or list in screen 120. The user is able to toggle back and forth between screens 116, 118 and 120, as indicated by the arrows “B” and “F”. Additional toggle buttons 122 may be present on the search screen 102.

When a user is on the search screen 102, which may be arrived at from exploration screen 96, for example, he may search for trades in his or a different locality. They may be trades open to offer or completed trades. Trades may be searched for by inputting key words or by selecting one or more categories defined by the tags that are associated with the postings. A user may also search for other users in the locality, and such other users may be filtered by the level of reputation, the number of trades, whether the trader predominantly offers goods or services, or whether the trader predominantly posts asks for goods or services. Other filters may be used for searching, such as date or time.

The trade main page 104 is for posting a trade. A user ideally must have created an account and logged into the system to be able to do this, although in some embodiments it is feasible that an opportunity is given to users to post a trade as a guest user. The main trade page 104 leads to a page 124 in which the user is requested about what kind of trade he wishes to post, i.e. whether it is an ask or an offer. He is also asked for information about the trade. He is also given the opportunity to post the trade to social networks such as Twitter™ or Facebook™. On screen 126, the user can upload one or more photos of the item offered, or possibly a photo of an item asked for. On page 128, the user is given a chance to confirm the post. On subsequent screen 130, the user is shown what the post looks like, and both a listing view and a detailed view can be displayed. Private and/or public messages can be attached to posted trades, as well as, for example, the details of any closure or execution of the trade.

The main inbox page 106 leads to screen 132, which shows a list view of the user's inbox. It may also display confirmed trades that are saved for record keeping. The confirmed trades that the inbox displays may be trades owing to the user and trades owed by the user, and as such, the inbox may act as a ledger. As well, completed trades may be displayed. The inbox may also sync with the user's calendar in order to help the user organize ongoing transactions. This is unlike other trade systems, which are very flat, where one enters, makes a transaction, leaves, and does not enter back until another transaction is required. In other trade systems, one is defined as either a vendor or a customer. In contrast, the present system encourages users to be both vendor and customer at the same time, and with the features of the inbox, it encourages users to make the system an ongoing part of their lives and how they give and receive value.

Notifications 134 may be shown on screen 132 for friend requests to trade or chat, with the user or the user's circles. On tapping such a notification, the user may be led to screen 136 where the user can communicate with the friend. Screen 136 also shows the detailed history of a chat between the user and another user.

The main profile page 108 leads to different pages relating to a user's profile. Screen 150 displays a list of the user's followers and screen 152 displays a list of the other users that the user is following. Screen 154 is a detail view of one or more of the followers listed in screen 150. Screen 156 is a detail view of one or more of the users that are being followed and are listed in screen 108. Screen 158 shows the user's rankings. The main profile page 108 leads to page 140, on which the user can enter or amend his profile. Screen 140 leads to screen 142, which displays how the user's profile appears to other users. The user can scroll back and forth between various different pages of his profile, as indicated by the arrows “B” and “F”. Screen 144 shows the user's trade history, which can also be scrolled through as indicated by the arrows “B” and “F”. It can also show a user's exploration of various trades that are posted, or the user's various searches.

A typical trade between two users is demonstrated by the lines on the screen map. The finely dotted line represents the actions of a user who posts a trade. As can be seen on the map, the user that posts the trade goes via main trade screen 104; through screen 124 where the trade information is input; screen 128 where the trade is confirmed; and screen 130, which displays the posted trade. The user's trade is then automatically viewable on screens 112 and 114 of another user who has requested that such trades appear on his feed. The dashed line represents the actions of the other user, who navigates from his home screen to screens 112 and 114, which show respectively a list view and a detailed view of the newly posted trade. If the trade is indeed of interest to this other user, he then navigates to screen 144 where he can compare the trade with previous trades, and/or screen 136 where he can initiate a chat with the user who posted the trade.

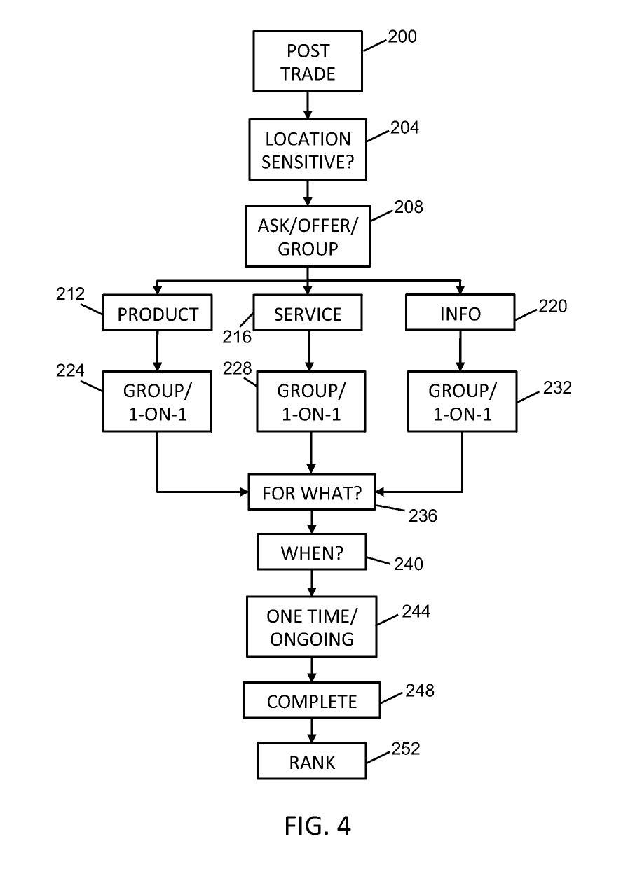

FIG. 4 is a flow chart that shows how the system can facilitate trades that involve multiple parties. In step 200, a user posts a trade. In step 204, the user is asked if the trade is location sensitive, and, if so, to what extent. In step 208, the user defines whether the trade is an ask or an offer, or whether it is a group trade. If it is a group trade, the user may both offer and ask for something.

The posted trade is then classified as a product in step 212, a service in step 216 or information in step 220. In each case, the user then communicates one-on-one or within the group, in steps 224, 228 and 232 respectively, in order to discuss and/or finalize the trade. For example, they may discuss what is being offered in return for the ask, or what is being offered in return for the offer, in step 236. They may discuss when the trade is to be executed, in step 240, and whether it will be a one-time trade or ongoing in step 244. After the trade has been completed, in step 248, the system then requests the various users participating in the trade to rank their experiences, and automatically updates their rankings based on the feedback, in step 252. Some rankings may also automatically be adjusted without user interaction, such as ranking based on a user's frequency of using the system to facilitate trades. In effect, the rank of a user may consist of multiple constituent ranks or they may all be combined into a single rank.

Various different algorithms may be used for determining a user's rank. A degree of influence may be attributed to each user, based on the number of people the user interacts with, and/or the number of trades the user concludes, and/or the frequency at which the user trades.

Businesses may pay the owner of the system to feature various of their trades, or to otherwise display them in prominence compared to other postings.

Some trades may be urgent. For example, if someone is moving house and find they are short-handed, they may desire a group of people to help move furniture etc. on the day in return for free pizza. Users, as well as businesses may pay the owners of the system to give prominence to their trades.

Geo-tagging may be used by the system, and may be automatically used to tag the trades that a user posts. In other cases, the geo-tagging may be used to limit the trades and/or other activity that a user can see to trades and/or activities within a predetermined distance of the user's location. Likewise, the system may record who has looked at a particular trade and/or activity, and their location. In some cases, such data may be made available without specifying the identities of the viewing users, but instead revealing only the locations, within a certain granularity, of the users viewing the posted trades and/or activities.

The advantage of the system is that it permits the discovery of goods and services available for trade in a given neighbourhood and provides a platform to facilitate dialogue in reaching a negotiated agreement. Confidence in trading is supported by peer ranking based on trustworthiness, and on current and historical review data. Delivery of goods and services, and IOU's can be tracked because it provides opportunities for feedback to be given, which is desired by the users in order to build social currency. Furthermore, the system can assist with the closing of multi-party trades.

The system can be used to channel donations of cash, products or services to charities, which may be local charities. The system can keep track of such donations and increase the reputation of the users who donate, award them with virtual badges or otherwise increase their social currency.

The detailed descriptions above have been presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions.

All of the methods and processes described herein may be embodied in, and fully automated via, software code modules executed by one or more computing devices. The code modules may be stored in any type(s) of computer-readable media or other computer storage system or device (e.g., hard disk drives, solid state memories, etc.). The methods may alternatively be embodied partly or wholly in specialized computer hardware, such as ASIC or FPGA circuitry. The results of the disclosed methods and tasks may be persistently stored by transforming physical storage devices, such as solid state memory chips and/or magnetic disks, into a different state.

In general, unless otherwise indicated, singular elements may be in the plural and vice versa with no loss of generality. The use of the masculine can refer to masculine, feminine or both.

The present description is of the best presently contemplated mode of carrying out the subject matter disclosed and claimed herein. The description is made for the purpose of illustrating the general principles of the subject matter and not to be taken in a limiting sense; the subject matter can find utility in a variety of implementations without departing from the scope of the disclosure made, as will be apparent to those of skill in the art from an understanding of the principles that underlie the subject matter.

The foregoing embodiments of the invention can be varied in many ways. For example, steps in the flowchart may be performed in a different order to that shown, certain steps may be omitted or others may be added, while still providing a suitable embodiment of the invention. At least part of the server and part of the network may be integrated in one computing device. The database and the server may be incorporated in the same or different devices. Any determination step taken by the processor may be undertaken by the processor performing a calculation or by reading data that is stored, either within the system or from an external source.

Such present or future variations are not to be regarded as a departure from the scope of the invention, and all such modifications as are obvious to one skilled in the art are intended to be included within the scope of the following claims.

1. A computer implemented method for trading, the method comprising:
receiving, by a processor, from a first user device, an input describing a trade;
adding, by the processor, the trade to a database;
transmitting, by the processor, the trade to a second user device;
receiving, by the processor, from one or both of the first and second user devices, an input indicating that the trade has been closed;
receiving, by the processor, from one or both of the first and second user devices, an input indicating that the trade has been executed;
sending, by the processor, a prompt to the first and second user devices requesting feedback relating to the trade;
receiving, by the processor, feedback relating to the trade from one or both of the first and second user devices; and
updating, by the processor, a rank of one or both of a first user using the first user device and a second user using the second user device based on the received feedback.

2. The method of claim 1, further comprising the processor:
receiving, from the second user, an IOU;
storing the IOU in the database;
clearing the IOU after receiving from the first user a notification that the second party has executed the trade.

3. The method of claim 1, further comprising the processor updating the rank of both first and second users based on each user having participated in the trade.

4. The method of claim 3, further comprising the processor updating the rank of both first and second users based on a total number of trades executed by the respective user.

5. The method of claim 3, further comprising the processor updating the rank of both first and second users based on a number of trades executed per unit time by the respective user.

6. The method of claim 3, further comprising the processor updating the rank of both first and second users based on one or more of a number of trades negotiated by the respective user without closing.

7. The method of claim 3, further comprising the processor updating the rank of both first and second users based on a number of trades executed in a predetermined period of time ending in the present.

8. The method of claim 1, wherein the trade is associated with a location, and the trade is only transmitted to the second user device if the processor receives an indication of the location from the second user device.

9. A computer readable medium for trading, the medium comprising computer readable instructions, which, when executed by one or more processors cause the one or more processors to:
receive, from a first user device, an input describing a trade;
add the trade to a database;
transmit the trade to a second user device;
receive, from one or both of the first and second user devices, an input indicating that the trade has been closed;
receive, from one or both of the first and second user devices, an input indicating that the trade has been executed;
send a prompt to the first and second user devices requesting feedback relating to the trade;
receive feedback relating to the trade from one or both of the first and second user devices; and
update a rank, of one or both of a first user using the first user device and a second user using the second user device, based on the received feedback.

10. The medium of claim 9, further causing the one or more processors to:
receive an IOU from the second user;
store the IOU in the database;
clear the IOU after receiving from the first user a notification that the second user has executed the trade.

11. The medium of claim 9, further causing the one or more processors to update the rank of both first and second users based on each user having participated in the trade.

12. The medium of claim 11, further causing the one or more processors to update the rank of both first and second users based on a total number of trades executed by the respective user.

13. The medium of claim 11, further causing the one or more processors to update the rank of both first and second users based on a number of trades executed per unit time by the respective user.

14. The medium of claim 11, further causing the one or more processors to update the rank of both first and second users based on one or more of a number of trades negotiated by the respective user without closing.

15. The medium of claim 11, further causing the one or more processors to update the rank of both first and second users based on a number of trades executed in a predetermined period of time ending in the present.

16. The medium of claim 9, wherein the trade is associated with a location, and the trade is only transmitted to the second user device if the processor receives an indication of the location from the second user device.

17. A system for trading, comprising:
one or more computer readable media comprising a database and computer readable instructions; and
a processor that executes said computer readable instructions, which cause the processor to:
receive, from a first user device, a first input describing a first trade;
receive, from a second user device, a second input describing a second trade;
receive, from a third user device, a third input describing a third trade;
add the first, second and third trades to a database;
receive, from the first user device, an input indicating that the first trade has been closed with a user of the second device;
receive, from the second user device, an input indicating that the second trade has been closed with a user of the third device;
receive, from the third user device, an input indicating that the third trade has been closed with a user of the first device;
receive, from the first, second and third user devices, inputs indicating that the respective trades have been executed;
receive, from the first, second and third user devices, feedback relating to the respective trades; and
update a rank of a first user using the first user device, a rank of a second user using the second user, and a rank of a third user using the third user device based on the respective received feedback.

18. The system of claim 17, in which the computer readable instructions further cause the processor to:
receive an IOU from one of said users;
store the IOU in the database;
clear the IOU after receiving, from another of said users to whom the IOU is owed, a notification that the respective trade has been executed.

19. The system of claim 17, wherein one of said trades is an IOU.

20. The system of claim 17, wherein said trades are executed in a common locality.
